(19) United States
(12) Patent Application Publication
(10) Pub. No.: US 2018/0024575 A1
(43) Pub. Date: Jan. 25, 2018

(54) FLUID DELIVERY DEVICE

(71) Applicant: L'Air Liquide, Société Anonyme pour l'Etude et l'Exploitation des Procédés Georges Claude, Paris (FR)

(72) Inventors: Romuald DE POTTER, Taverny (FR); Benjamin FISCHER, L'Haÿ-les-Roses (FR); Antoine FRENAL, Ezanville (FR); Renaud LIGONESCHE, Herblay (FR); Olivier ONDO, Rosny-sur-Seine (FR)

(21) Appl. No.: 15/654,990

(22) Filed: Jul. 20, 2017

(30) Foreign Application Priority Data
Jul. 20, 2016 (FR) 1656907

(51) Int. Cl. G05D 7/06; F16K 31/02; F16K 37/00

(52) U.S. Cl. CPC G05D 7/0635; F16K 37/005; F16K 31/02; F16K 15/00

(57) ABSTRACT

Device comprising a valve comprising a fluid circuit accommodated at least in part in a body, the circuit having an upstream extremity and a downstream extremity and at least one flow control means, the valve comprising an actuating means, the at least one control means comprising a flow regulator being situated in a section of the fluid circuit contained in a regulation module mounted in a removable manner on the body, the circuit comprising a first extremity opening onto the body at the level of a first orifice, the section of the fluid circuit of the regulation module being equipped with an upstream extremity comprising a first fluid connector configured for connection in a sealed manner at the level of the first orifice when the module is in position mounted on the body.

### CROSS REFERENCE TO RELATED APPLICATIONS

This application claims the benefit of priority under 35 U.S.C. §119 (a) and (b) to French Patent Application No. 1656907 filed Jul. 20, 2016, the entire contents of which are incorporated herein by reference.

### BACKGROUND

The invention relates to a fluid delivery device.

### SUMMARY

The invention relates more specifically to a fluid delivery device comprising a valve for fluid under pressure, with or without an integral pressure relief device, comprising a body, a fluid circuit accommodated at least in part in the body, the circuit having an upstream extremity intended to be linked to a pressurized fluid reservoir and a downstream extremity intended to be linked to a receiving device, the circuit comprising at least one means for controlling the flow in the circuit, the valve comprising an actuating means for operating at least one means for controlling the flow, the at least one control means comprising a fixed or adjustable flow regulator.

In order to improve the functionality of a valve for cylinder(s) of fluid under pressure, it is customary to provide modular or non-modular fluid control means. These means are provided in order to interact with a valve for fluid under pressure in order to adapt the function of the valve.

The adaptation of the flow control function requires the provision of modular elements which meet the criteria of reliability, safety and proper operation. The fluid connections and, where appropriate, the electrical and mechanical connections between different separable electronic devices must specifically meet these requirements.

One aim of the invention is to propose a valve having an improved modular electronic architecture.

One aim of the present invention is to address all or some of the disadvantages of the prior art noted above.

For this purpose, the valve according to the invention, which is consistent, furthermore, with the generic definition provided by the above preamble, is characterized essentially in that the flow regulator is situated in a section of fluid circuit contained in a regulation module mounted in a removable manner on the body, the circuit accommodated in the body comprising a first extremity opening onto the body at the level of a first orifice, the section of fluid circuit of the regulation module being equipped with an upstream extremity comprising a first fluid connector configured for connection in a sealed manner at the level of the first orifice when the module is in position mounted on the body, such that the flow regulator regulates the flow of fluid passing through the circuit (3, 13) upstream of the downstream extremity.

Furthermore, embodiments of the invention may include one or a plurality of the following characterizing features:
the first fluid connector of the regulation module and the first orifice of the body form a male-female fluid connection system comprising a sealing system such as an O-ring,
the first fluid connector projects from the regulation module and comprises a sealing joint such as an O-ring,
the downstream extremity of the circuit opens onto the regulation module and is equipped with a male or female outlet connector,
the fluid circuit situated inside the body comprises a first section extending between the upstream extremity and the first orifice and a second section extending between a second orifice opening onto the body and the downstream extremity, the section of circuit of the regulation module comprising a downstream extremity comprising a second fluid connector configured for connection in a sealed manner at the level of the second orifice when the regulation module is in position mounted on the body, such that, when the regulation module is in position mounted on the body, the section of circuit of the regulation module ensures a fluid connection between the first section and the second section of the circuit of the body and the regulation of the fluid flow via the flow regulator,
the downstream extremity opens onto the body and is equipped with a male or female outlet connector,
the second fluid connector of the regulation module and the second orifice of the body form a male-female fluid connection system comprising a sealing system such as an O-ring,
the body of the valve comprises a housing intended to receive the regulation module, the housing comprising a horizontal ceiling when the valve is in its vertical operating position, the ceiling being intended to receive a base of the regulation module when the regulation module is in position mounted on the body, the first orifice opening at the level of said ceiling of the housing,
the second orifice opens at the level of said ceiling of the housing,
the flow regulator situated in the regulation module is a variable flow regulator controlled by an electronic means for the acquisition and processing of data integrated in the valve and comprising an antenna configured to receive a remote control signal from the flow regulator in order to control and modify remotely the flow imposed by the latter,
the electronic means for the acquisition and processing of data is at least partially accommodated in the regulation module, the device comprising a pressure sensor configured for measuring the pressure in the circuit in the body, said pressure sensor being connected to an electrical connector opening onto the body in the housing, the regulation module comprising on its external surface a combined electrical connector connected to the electronic means for the acquisition and processing of data and configured to transmit the measurement information from the pressure sensor to the electronic means for the acquisition and processing of data when the regulation module is in position mounted on the body,
the regulation module is held on the body by snap-in engagement and/or by removable holding means such as a system of screws and nut(s) or tapped holes,
the flow regulator comprises at least one of the following: a fixed calibrated orifice, an orifice of adjustable size,
the flow regulator comprises a variable orifice mechanism of the piezoelectric type,
the flow regulator comprises a variable orifice mechanism with a movable spool,
the valve comprises at least a first electronic functional device intended to exchange data with an electronic device of the regulation module, the body of the valve comprising a contact(s) device situated in the housing intended to interact with a combined set of electrical contact(s) situated on the regulation module when the latter is in position mounted on the body of the valve,
the regulation module is movable in translation in a first direction in relation to the housing between a mounted position and an unmounted position in relation to the body, the contact(s) device being disposed on a wall of the housing situated in a plane parallel to said first direction, such that the contact between the contact(s) device and the combined set of electrical contact(s) takes place in a plane parallel to the first direction,
the valve comprises a mounting extremity comprising mobile attachment means intended to interact with additional attachment means to form a system for the rapid connection of the valve to another valve or to a fluid circuit, the valve comprising a mobile support component forming an actuating means for the mobile means of attachment such as a means for locking and/or unlocking the mobile attachment means,
the valve is fluidly connectable to another valve known as the “basic valve” and is possibly integral with at least one cylinder of fluid under pressure, the valve comprising a mobile means (such as a check-valve actuator) of which the displacement is operated by the actuating means for operating the opening or the closing of an isolation valve of the basic valve to which said valve is connected in a removable manner,
the actuating means comprises at least one of the following: a rotating wheel, a push-button, a lever pivoting on the body.

The invention also relates to a gas flow regulation module intended to be connected in a removable manner to the body of a valve for fluid under pressure of a device in accordance with any one of the characterizing features above or below, comprising a housing accommodating a fluid circuit comprising a first upstream extremity opening onto the body at the level of a first orifice and a second downstream extremity opening at the level of a downstream orifice, the circuit comprising a flow regulator intended to regulate the flow of fluid circulating in said circuit, the first orifice opening onto a lower horizontal surface of the housing and comprising a first fluid connector configured for connection in a sealed manner at the level of a combined orifice of a valve, the housing being equipped with means of attachment by snap-in engagement and/or configured to interact with a system of screws and nut(s) or tapped holes to ensure the mounting of the housing on a valve.

According to other possible distinguishing features:
the circuit of the regulation module comprises a downstream extremity comprising a second fluid connector configured for connection in a sealed manner at the level of the second orifice, the second connector being situated on the lower horizontal surface of the housing,
the flow regulator is a variable flow regulator controlled by an electronic means for the acquisition and processing of data integrated in the valve and comprising an antenna configured to receive a remote control signal from the flow regulator in order to control and modify remotely the flow imposed by the latter.

The invention may also relate to a cylinder or a group of cylinders of fluid under pressure (frame) comprising a suchlike device.

The invention may also relate to any alternative device or procedure comprising any combination of the characterizing features above or below.

### BRIEF DESCRIPTION OF THE DRAWINGS

Other distinguishing features and advantages will be appreciated from a perusal of the following description, made with reference to the figures, in which:

FIG. 1 depicts a perspective, schematic and partial view, illustrating an illustrative embodiment of a valve according to the invention in an unmounted position,

FIG. 2 depicts a perspective, schematic and partial view from below, illustrating an illustrative embodiment of an example of a regulation module intended to be associated with the valve in FIG. 1,

FIG. 3 depicts a schematic and partial side view, illustrating another illustrative embodiment of a regulation module that is likely to be associated with the valve in FIG. 1,

FIG. 4 depicts a schematic and partial side view, illustrating another illustrative embodiment of a regulation module that is likely to be associated with the valve in FIG. 1,

FIG. 5 depicts a schematic and partial side view, illustrating an ummounted valve,

FIG. 6 depicts a schematic and partial side view, illustrating an ummounted valve,

FIG. 7 depicts a schematic and partial side view, illustrating another illustrative embodiment of a valve according to the invention,

FIG. 8 depicts a schematic and partial side view, illustrating another illustrative embodiment of a valve according to the invention,

FIG. 9 depicts a schematic and partial side view, illustrating another illustrative embodiment of a regulation module for a valve according to the invention,

FIG. 10 depicts a schematic and partial side view, illustrating an illustrative embodiment and an illustrative application of a device according to the invention,

FIG. 11 depicts a schematic and partial perspective view from below, illustrating another illustrative embodiment of an example of a regulation module intended to be associated with the valve in FIG. 1 in particular.

### DESCRIPTION OF PREFERRED EMBODIMENTS

The valve 1 illustrated in the figures comprises a body 2 accommodating at least a part 3 of a fluid circuit 3, 13.

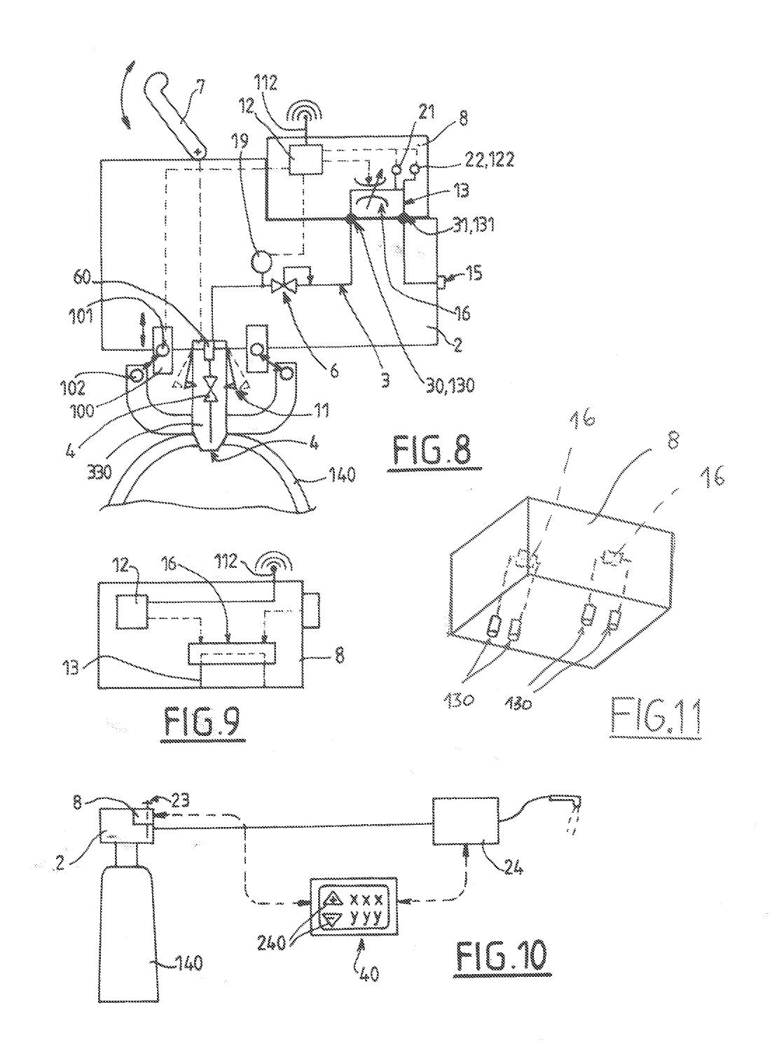

The fluid circuit 3, 13 (in particular for gas under pressure) has an upstream extremity 4 intended to be linked to a pressurized fluid reservoir (for example a cylinder 14 or a group of cylinders of gas under pressure; see FIG. 8).

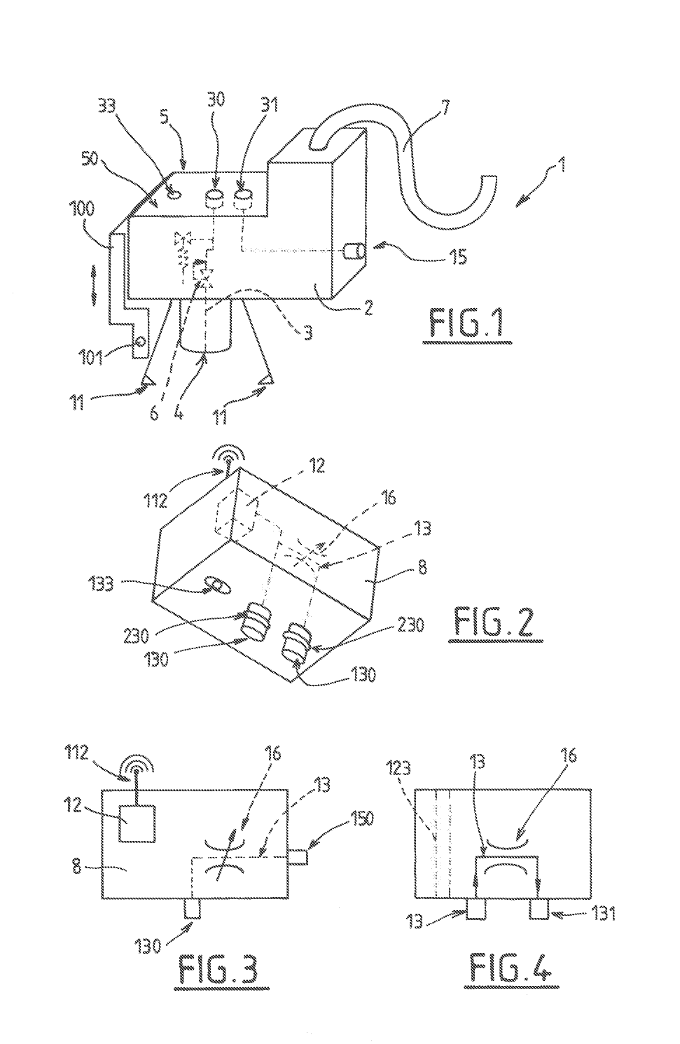

The circuit 3, 13 comprises at least one downstream extremity (15, see FIG. 1; 150, see FIG. 3) intended to be linked to a receiving device for the gas, for example a welding apparatus 24 or some other apparatus (see FIG. 10).

Conventionally, the circuit 3, 13 comprises at least one means 6, 60 for controlling the flow in the circuit 3, 13.

In the example in FIG. 1, the section of the circuit 3 situated in the body 2 of the valve 1 comprises a pressure relief device 6 for lowering the pressure to a fixed or adjustable predetermined value.

The valve 1 comprises in addition an actuating means 7 for operating at least one flow control means (for operating the relief device or an isolation valve or a check-valve actuator, for example).

In the example in FIG. 1, the actuating means 7 is a pivoting lever. Of course, alternatively or cumulatively, the actuating means may comprise a component that is movably mounted in translation or a rotating wheel or a button (see, for example, FIGS. 5 to 7).

Likewise, the valve 1 is not limited to the example in FIG. 1. For example, as illustrated in FIGS. 5 to 8, the valve may comprise in addition (or as an alternative) to the relief device 6, a movable check-valve actuator 60 capable of actuation for operating the opening of a check-valve 4 of another valve 330 or apparatus to which the valve 1 is connected. This check-valve actuator 60 may be actuated by the actuating means 7.

The valve 1 in addition comprises a fixed or adjustable flow regulator 16, which is situated in a section 13 of the fluid circuit contained in a regulation module 8 mounted in a removable manner on the body 2.

The part of the circuit 3 accommodated in the body 2 of the valve comprises a first extremity opening onto the body 2 at the level of a first orifice 30.

The section of circuit 13 for fluid situated in the regulation module 8 is equipped with an upstream extremity comprising a first fluid connector 130 configured for connection in a sealed manner at the level of the first orifice 30 when the module 8 is in position mounted on the body 2, such that the flow regulator 16 regulates the flow of fluid passing through the circuit 3, 13 upstream of the downstream extremity 15.

The first fluid connector 130 of the regulation module 8 and the first orifice 30 of the body 2 form a male-female fluid connection system comprising a sealing system 230 such as an O-ring, for example. For example, the first fluid connector 130 is of the male type and projects from the regulation module 8 and comprises a sealing joint 230 such as an O-ring.

The circuit 3 for fluid situated in the body 2 comprises a first section extending between the upstream extremity 4 and the first orifice 30 and a second section extending between a second orifice 31 opening onto the body 2 and a downstream outlet extremity 15 equipped, for example, with a connector.

In the example in FIGS. 2, 4 and 5 to 9, the section of the circuit 13 situated in the regulation module 8 comprises a downstream extremity comprising a second fluid connector 131 configured for connection in a sealed manner at the level of the second orifice 31 when the regulation module 8 is in position mounted on the body 2. This means that, when the regulation module 8 is in position mounted on the body 2, the section of circuit 13 of the regulation module 8 thus assures a fluid connection between the first section and the second section of the circuit 3 of the body 2 and the regulation of the fluid flow via the flow regulator 16. This means that the gas passes through the regulation module 8 before returning into the body 2.

In this particular case, the gas, of which the flow has been regulated, exits at the level of an extremity 15 on the body 2.

As for the first connector 130, the second fluid connector 131 of the regulation module 8 and the second orifice 31 of the body 2 form a male-female fluid connection system comprising a sealing system 230 such as an O-ring (for example of the same type as for the first connector 130).

This gives a reliable and safe mechanical and fluid connection between these two entities 2, 8.

As illustrated, the body 2 of the valve 1 preferably comprises a housing 5 intended to receive the regulation module 8. The housing 5 comprises a ceiling 50 that is substantially horizontal when the valve 1 is in its vertical operating position. The ceiling 50 is intended to receive the base (lower face) of the regulation module 8 when the regulation module 8 is in position mounted on the body 2. As illustrated, the first orifice 30 and the second orifice 31 are preferably open at the level of said ceiling 50 of the housing 5.

The two connectors 130, 131 of the regulation module are thus situated on the lower face of the latter.

This arrangement improves the strength and the protection of the fluid connections (30-130, 31-131) and contributes to the correct positioning and holding of the module 8 on the body 2.

The regulation module 8 is held on the body 2 by snap-in engagement and/or by removable holding means such as a system of screws and nut(s) or tapped holes (see, for example, ref. 123, 23 in FIGS. 4 and 10).

As illustrated in FIG. 3, the regulation module 8 may include a single inlet connector 130 intended to interact with the first orifice 30 and an outlet connector 150 situated on the module 8. This means that the fluid emerging from the first orifice 30 does not flow back into the body 2 of the valve.

The flow regulator 16 situated in the regulation module 8 may be a fixed flow regulator (see FIG. 4) or a variable flow regulator (see FIGS. 2 and 3 in particular).

Preferably, the flow regulator 16 is controlled by an electronic means 12 for the acquisition and processing of data preferably integrated in the module 8 and comprises an antenna 112 configured to receive a remote control signal from the flow regulator 16 in order to control and modify remotely the flow imposed by the latter.

The valve 1 may comprise at least one pressure (or other) sensor 19, 20, 21, 122 configured for measuring at least the pressure in the circuit 3. At least one sensor 19 may be connected to an electrical connector 33 opening onto the body 2 in the housing 5, for example in a manner adjacent to the orifices 30, 31.

In order to transmit these data to the electronic acquisition means 12, the regulation module 8 may comprise on its lower surface a combined electrical connector 133 connected to the electronic means 12 for the acquisition and processing of data and configured. These two electrical connectors are configured to transmit the measurement information from the sensor 19 to the electronic means 12 for the acquisition and processing of data when the regulation module 8 is in position mounted on the body 2.

The flow regulator 16 comprises, for example, a variable orifice mechanism of the piezoelectric type or a variable orifice mechanism with a movable spool, or some other suitable system.

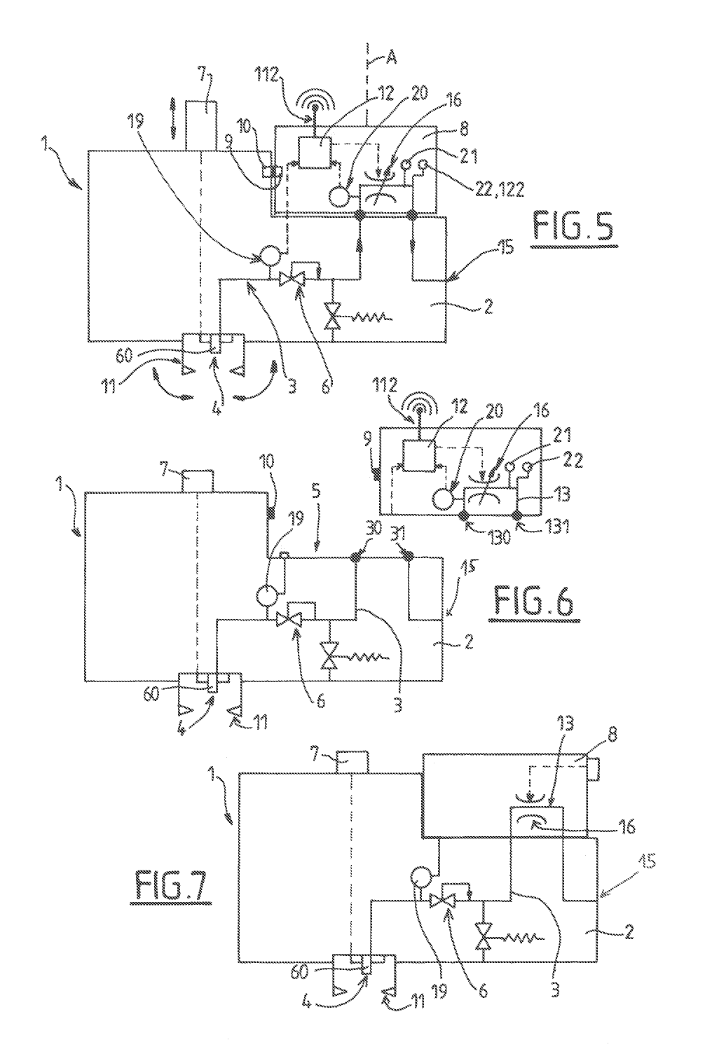

As illustrated in FIGS. 1 and 8, the valve 1 may comprise at least a first electronic functional means 101 intended to exchange data with the electronic means 12 of the regulation module 8. For this purpose, the body 2 of the valve may comprise a contact device 10 situated in the housing 5 intended to cooperate with a combined set of electrical contacts 9 situated on the regulation module 8 when the latter is in position mounted on the body 2 of the valve (see FIGS. 5 and 6 which illustrate these electrical contacts schematically).

For example, the regulation module 8 is movable in translation in a first direction A (see FIG. 5) in relation to the housing 5 between a mounted position and an unmounted position in relation to the body 2. Preferably, the contact device 10 is disposed on a wall of the housing situated in a plane parallel to said first direction A. The contact between the contact device 10 and the combined set of electrical contacts 9 thus takes place in a plane parallel to the first direction A.

In this way, when the module 8 is correctly mounted on the body 2 of the valve, a physical electrical connection is established permitting the transmission of data or energy, for example.

As illustrated in FIGS. 1 and 5, and in particular in FIG. 8, the valve 1 may comprise a mounting extremity comprising mobile means 11 of attachment intended to interact with additional attachment means to form a system for the rapid connection of the valve 1 to another valve 330 or to a fluid circuit. The valve 1 may comprise a mobile support component 100 on the body forming an actuating means for the mobile means 11 of attachment, such as a means for locking and/or unlocking the mobile means 11 of attachment.

In addition, the valve 1 may comprise an information carrier or a wireless electronic reader configured to exchange information wirelessly with another electronic information carrier 102, such as an RFID tag or a transponder (with near field communication, “NFC”, for example).

These data carriers may comprise a passive transponder without an electromagnetic wave generator device, an active transponder comprising a device for generating electromagnetic waves, the transponder comprising an electronic data read-only memory or data reading and (re)writing memory, with or without a battery.

This means that information (nature of the gas, references of the cylinder . . . ) may be transmitted wirelessly between the cylinder 140 or the group of cylinders and the valve 1 and then the module 8 via the transponders 102, 101.

In addition, as illustrated in FIGS. 1 and 8, the electronic communication device may be accommodated in the mobile support 100.

As illustrated schematically in FIG. 11, the module 8 may include two (or more) separate sets of fluid connectors 130 connected respectively to respective flow control means 16 (for example flow regulators, relief devices or some other devices) permitting a plurality of operating configurations of the module 8 depending on whether the module 8 is attached to the valve via one or other of the sets of connectors 130. Thus, for example, depending on whether the module 8 is attached to the valve in one direction or in another direction (via one or other of the sets of connectors 130), the flow of gas is regulated, for example, at different predetermined levels.

For example, each set of connectors 130 is associated with a different regulation means 16 (calibrated orifice with a different cross-section, for example). For example, the sets of connectors 130 are disposed symmetrically in relation to the centre of the lower surface of the module 8.

The operator may thus select one or other control means 16 by utilizing the associated connectors 130 (the respective positions may be associated with marking on the module 8).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A fluid delivery device comprising a valve for fluid under pressure, with or without an integral pressure relief device, comprising a body, a fluid circuit accommodated at least in part in the body, the circuit having an upstream extremity configured to be linked to a pressurized fluid reservoir and a downstream extremity configured to be linked to a receiving device, the circuit comprising at least one means for controlling the flow in the circuit, the valve comprising an actuating means for operating at least one means for controlling the flow, the at least one control means comprising a fixed or adjustable flow regulator,
wherein the flow regulator is situated in a section of fluid circuit contained in a regulation module mounted in a removable manner on the body, the circuit accommodated in the body comprising a first extremity opening onto the body at the level of a first orifice, the section of fluid circuit of the regulation module being equipped with an upstream extremity comprising a first fluid connector configured for connection in a sealed manner at the level of the first orifice when the module is in position mounted on the body, such that the flow regulator regulates the flow of fluid passing through the circuit upstream of the downstream extremity.

2. The device of claim 1, wherein the first fluid connector of the regulation module and the first orifice of the body form a male-female fluid connection system comprising a sealing system.

3. The device of claim 1, wherein the first fluid connector projects from the regulation module and comprises a sealing joint.

4. The device of claim 1, wherein the downstream extremity of the circuit opens onto the regulation module and is equipped with a male or female outlet connector.

5. The device of claim 1, wherein the fluid circuit situated inside the body comprises a first section extending between the upstream extremity and the first orifice and a second section extending between a second orifice opening onto the body and the downstream extremity, the section of circuit of the regulation module comprising a downstream extremity comprising a second fluid connector configured for connection in a sealed manner at the level of the second orifice when the regulation module is in position mounted on the body, wherein, when the regulation module is in position mounted on the body, the section of circuit of the regulation module ensures a fluid connection between the first section and the second section of the circuit of the body and the regulation of the fluid flow via the flow regulator.

6. The device of claim 5, wherein the downstream extremity opens onto the body and is equipped with a male or female outlet connector.

7. The device of claim 5, wherein the second fluid connector of the regulation module and the second orifice of the body form a male-female fluid connection system comprising a sealing system.

8. The device of claim 1, wherein the body of the valve comprises a housing configured to receive the regulation module, the housing comprising a horizontal ceiling when the valve is in the vertical operating position, the ceiling being configured to receive a base of the regulation module when the regulation module is in position mounted on the body, and in that the first orifice opens at the level of said ceiling of the housing.

9. The device of claim 1, wherein the flow regulator situated in the regulation module is a variable flow regulator controlled by an electronic means for the acquisition and processing of data integrated in the valve and comprising an antenna configured to receive a remote control signal from the flow regulator in order to control and modify remotely the flow imposed by the latter.

10. The device of claim 1, wherein the regulation module is held on the body by snap-in engagement and/or by removable holding means.

11. A gas flow regulation module configured to be connected in a removable manner to the body of a valve for fluid under pressure of a device in accordance with claim 1, comprising a housing accommodating a fluid circuit comprising a first upstream extremity opening onto the body at the level of a first orifice and a second downstream extremity opening at the level of a downstream orifice, the circuit comprising a flow regulator configured to regulate the flow of fluid circulating in said circuit, the first orifice opening onto a lower horizontal surface of the housing and comprising a first fluid connector configured for connection in a sealed manner at the level of a combined orifice of a valve, the housing being equipped with means of attachment by snap-in engagement and/or being configured to interact with a system of screws and nut(s) or tapped holes in order to ensure the mounting of the housing on a valve.

12. The regulation module of claim 11, wherein the circuit of the regulation module comprising a downstream extremity comprising a second fluid connector configured for connection in a sealed manner at the level of the second orifice, the second connector being situated on the lower horizontal surface of the housing.

13. The regulation module of claim 11, wherein the flow regulator is a variable flow regulator controlled by an electronic means for the acquisition and processing of data integrated in the valve and comprising an antenna configured to receive a remote control signal from the flow regulator in order to control and modify remotely the flow imposed by the latter.
